(19) United States
(12) Patent Application Publication
(10) Pub. No.: US 2010/0056721 A1
(43) Pub. Date: Mar. 4, 2010

(54) ARTICLES PREPARED FROM CERTAIN HYDROGENATED BLOCK COPOLYMERS

(76) Inventors: KATHRYN WRIGHT, Katy, TX (US); Carl Willis, Houston, TX (US)

Correspondence Address: KRATON POLYMERS U.S. LLC, 16400 Park Row, HOUSTON, TX, 77084, US

(21) Appl. No.: 12/203,196

(22) Filed: Sep. 3, 2008

(51) Int. Cl. C08L 53/02; C08K 7/02

(52) U.S. Cl. 525/90; 525/185; 524/505; 524/502; 523/222

(57) ABSTRACT

The present invention relates to articles prepared from novel anionic block copolymers of mono alkenyl arenes and conjugated dienes, and to blends of such block copolymers with other polymers. The block copolymers are selectively hydrogenated and have the structure C-A-B₂-A-C or (C-A-B)ₙX, where the molecular weight of B₂ is twice that of B, n is an integer between 2 and about 30, X is the residue of a coupling agent, and wherein prior to hydrogenation each A block is a mono alkenyl arene homopolymer block, each B block is a polymer block of at least one conjugated diene and each C block is a polymer block of (i) ethylene, (ii) alpha olefins of 3 to 10 carbon atoms; or (iii) monomers of 1,3-butadiene having a vinyl content less than 10 mol percent prior to hydrogenation. The block copolymer may be blended with at least one other polymer selected from the group consisting of olefin polymers, styrene polymers and amorphous resins.

### BACKGROUND OF THE INVENTION

1. Field of the Invention

This invention relates to articles prepared from novel anionic hydrogenated block copolymers of mono alkenyl arenes and conjugated dienes, and to blends of such block copolymers with other polymers and extending oils. The invention also relates to formed articles and methods for forming articles from such novel block copolymers.

2. Background of the Art

The preparation of block copolymers of mono alkenyl arenes and conjugated dienes is well known. One of the first patents on linear ABA block copolymers made with styrene and butadiene is U.S. Pat. No. 3,149,182. These polymers in turn could be hydrogenated to form more stable block copolymers, such as those described in U.S. Pat. Nos. 3,595,942, 3,670,054, 6,703,449, 7,169,848 and Re. 27,145. These hydrogenated block copolymers have in turn been blended with many different polymers and oils for a large variety of end-use applications, including injection molding, extruded goods and polymer modifications. While there are many unique advantages for such blends and compounds, there is often a trade-off between improving properties and worsening compound flow. For example, an S-EB—S block copolymer having molecular weights of 70,000 g/mol is ideal for many compounding applications; formulations with melt flow rates >10 g/min at 200° C. and 5 kg are readily achievable due to the moderate viscosity of S-EB—S polymers in this molecular weight range. However, compounds of this block copolymer with extending oils and polyolefins have poor compression set and tensile strength when compared to block copolymer compounds based on higher molecular weight S-EB—S block copolymers.

What has now been found is that compounds containing the novel block copolymers of the present invention possess excellent compression set, tensile strength, and tear strength, with only a slight reduction in melt flow.

### SUMMARY OF THE INVENTION

The present invention relates to a novel block copolymer, and to formulations, blends, compounds and articles made from the novel block copolymer. Broadly, the novel block copolymer is a hydrogenated block copolymer of the structures C-A-B2-A-C or (C-A-B)nX, where B2 is two times B, n is an integer between 2 and about 30, X is the residue of a coupling agent, and wherein:
a. prior to hydrogenation each A block is a mono alkenyl arene homopolymer block, each B block is a polymer block of at least one conjugated diene and each C block is a polymer block of (i) ethylene, (ii) alpha olefins of 3 to 10 carbon atoms; or (iii) monomers of 1,3-butadiene having a vinyl content less than about 10 mol percent prior to hydrogenation;
b. subsequent to hydrogenation about 0-10% of the arene double bonds have been reduced, and at least about 90% of the conjugated diene double bonds have been reduced;
c. each A block having an average molecular weight between about 5,000 and about 20,000, each B block having an average molecular weight between about 20,000 and about 100,000, and each C block having an average molecular weight of between about 1,000 and about 7,000; and
d. the total amount of A blocks in the hydrogenated block copolymer is about 20 percent weight to about 35 percent weight and the total amount of C blocks in the hydrogenated block copolymer is about 2 and about 10 weight percent.

In one aspect of the present invention we have discovered that a novel composition comprising at least one hydrogenated block copolymer of the above structure, and optionally including another polymer, has superior properties for many applications. We have also discovered that these compositions can be used in various forming processes, and that they also have a number of advantages in processing.

Accordingly, the broad aspect of the present invention is an article comprising at least one hydrogenated block copolymer and, optionally, at least one other component selected from the group consisting of olefin polymers, styrene polymers, tackifying resins and polymer extending oils, wherein said hydrogenated block copolymer is a block copolymer of the structure (C-A-B)nX as shown above. In another aspect of the present invention we have shown that the article can be formed in a wide variety of processes, including injection molding, compression molding, over molding, dipping, extrusion, roto molding, slush molding, fiber spinning, blow molding, polymer modification, cast film making, blown film making and foaming.

The articles of the present invention have a number of surprising properties. In particular, formulations containing the new block copolymer, extending oil and polypropylene have improved tensile strength, tear strength, and compression set at elevated temperature, with only a slight reduction in melt flow.

In yet another aspect of the present invention, the article can be processed into the form of a film, sheet, multi layer laminate, coating, band, strip, profile, molding, foam, tape, fabric, thread, filament, ribbon, fiber, plurality of fibers, or fibrous web. A particularly interesting application is in thermoplastic films which retain the processability of styrenic block copolymers but exhibit improved tensile strength and tear strength.

Finally, the copolymers of the present invention can be compounded with other components not adversely affecting the copolymer properties. Exemplary materials that could be used as additional components would include, without limitation, pigments, antioxidants, stabilizers, surfactants, waxes, and flow promoters. The polymers of the present invention are useful in a wide variety of applications including, for example, molded and extruded goods such as toys, grips, handles, shoe soles, tubing, sporting goods, sealants, gaskets, and oil gels. The polymers of the present invention are also useful in alloys and blends, and as compatibilizers for a variety of polymers and other materials.

### DETAILED DESCRIPTION OF THE PREFERRED EMBODIMENTS

The key component of the present invention is the novel block copolymer containing highly crystalline end blocks (C) comprising (i) hydrogenated low vinyl 1,3-butadiene, (ii) polyethylene or (iii) polymers of C3-10 alpha olefins, mono alkenyl arene midblocks (A) and hydrogenated conjugated diene blocks (B), of the general structure (C-A-B)nX.

The base polymers needed to prepare the hydrogenated block copolymers of the present invention may be made by a number of different processes, including anionic polymerization, moderated anionic polymerization, and Ziegler-Natta polymerization. Anionic polymerization is described below in the detailed description, and in the patents referenced. Moderated anionic polymerization processes for making styrenic block copolymers have been disclosed, for example, in U.S. Pat. Nos. 6,391,981, 6,455,651 and 6,492,469, each incorporated herein by reference. Living Ziegler-Natta polymerization processes that can be used to make block copolymers were recently reviewed by G. W. Coates, P. D. Hustad, and S. Reinartz in Angew. Chem. Int. Ed., 2002, 41, 2236-2257; a subsequent publication by H. Zhang and K. Nomura (JACS Communications, 2005) describes the use of living Z-N techniques for making styrenic block copolymers specifically.

Starting materials for preparing the novel copolymers of the present invention include the initial monomers. The monomers used for A blocks are alkenyl arenes selected from styrene, alpha-methylstyrene, para-methylstyrene, vinyl toluene, vinylnaphthalene, and para-butyl styrene or mixtures thereof. Of these, styrene is most preferred and is commercially available, and relatively inexpensive, from a variety of manufacturers. The monomers used for B blocks are conjugated dienes such as 1,3-butadiene and substituted butadienes such as isoprene, piperylene, 2,3-dimethyl-1,3-butadiene, and 1-phenyl-1,3-butadiene, or mixtures thereof. Of these, 1,3-butadiene is most preferred. As used herein, and in the claims, “butadiene” refers specifically to “1,3-butadiene”. The monomers used for the C blocks are (i) ethylene, (ii) alpha olefins of 3 to 10 carbon atoms; or (iii) monomers of 1,3-butadiene having a vinyl content less than 10 mol percent prior to hydrogenation.

When the A blocks are polymers of ethylene, it may be useful to polymerize ethylene via a Ziegler-Natta process, as taught in the references in the review article by G. W. Coates et. al, as cited above, which disclosure is herein incorporated by reference. It is preferred to make the ethylene blocks using anionic polymerization techniques as taught in U.S. Pat. No. 3,450,795, which disclosure is herein incorporated by reference. The block molecular weight for such ethylene blocks will typically be between about 1,000 and about 7,000.

When the A blocks are polymers of alpha olefins of 3 to 10 carbon atoms, such polymers are also prepared by a Ziegler-Natta process, as taught in the references in the review article by G. W. Coates et. al, as cited above, which disclosure is herein incorporated by reference. Preferably the alpha olefins are propylene, butylene, hexane or octene, with propylene being most preferred. The block molecular weight for such alpha olefin blocks will typically be between about 1,000 and about 7,000.

With regard to the process to prepare the polymers, the anionic polymerization process comprises polymerizing the suitable monomers in solution with a lithium initiator. The solvent used as the polymerization vehicle may be any hydrocarbon that does not react with the living anionic chain end of the forming polymer, is easily handled in commercial polymerization units, and offers the appropriate solubility characteristics for the product polymer. For example, non-polar aliphatic hydrocarbons, which are generally lacking in ionizable hydrogen atoms make particularly suitable solvents. Frequently used are cyclic alkanes, such as cyclopentane, cyclohexane, cycloheptane, and cyclooctane, all of which are relatively non-polar. Other suitable solvents will be known to those skilled in the art and can be selected to perform effectively in a given set of process conditions, with polymerization temperature being one of the major factors taken into consideration.

Starting materials for preparing the block copolymers of the present invention include the initial monomers noted above. Other important starting materials for anionic polymerizations include one or more polymerization initiators. In the present invention such include, for example, alkyl lithium compounds such as s-butyllithium, n-butyllithium, t-butyllithium, amyllithium and the like and other organo lithium compounds including di-initiators such as the di-sec-butyl lithium adduct of m-diisopropenyl benzene. Other such di-initiators are disclosed in U.S. Pat. No. 6,492,469, each incorporated herein by reference. Of the various polymerization initiators, s-butyllithium is preferred. The initiator can be used in the polymerization mixture (including monomers and solvent) in an amount calculated on the basis of one initiator molecule per desired polymer chain. The lithium initiator process is well known and is described in, for example, U.S. Pat. Nos. 4,039,593 and Re. 27,145, which descriptions are incorporated herein by reference.

Polymerization conditions to prepare the block copolymers of the present invention are typically similar to those used for anionic polymerizations in general. In the present invention polymerization is preferably carried out at a temperature of from about −30° C. to about 150° C., more preferably about 10° C. to about 100° C., and most preferably, in view of industrial limitations, from about 30° C. to about 90° C. The polymerization is carried out in an inert atmosphere, preferably nitrogen, and may also be accomplished under pressure within the range of from about 0.5 to about 10 bars. This copolymerization generally requires less than about 12 hours, and can be accomplished in from about 5 minutes to about 5 hours, depending upon the temperature, the concentration of the monomer components, and the molecular weight of the polymer that is desired.

It is recognized that the anionic polymerization process could be moderated by the addition of a Lewis acid, such as an aluminum alkyl, a magnesium alkyl, a zinc alkyl or combinations thereof. The affects of the added Lewis acid on the polymerization process are 1) to lower the viscosity of the living polymer solution allowing for a process that operates at higher polymer concentrations and thus uses less solvent, 2) to enhance the thermal stability of the living polymer chain end which permits polymerization at higher temperatures and again, reduces the viscosity of the polymer solution allowing for the use of less solvent, and 3) to slow the rate of reaction which permits polymerization at higher temperatures while using the same technology for removing the heat of reaction as had been used in the standard anionic polymerization process. The processing benefits of using Lewis acids to moderate anionic polymerization techniques have been disclosed in U.S. Pat. Nos. 6,391,981; 6,455,651; and 6,492,469, which are herein incorporated by reference. Related information is disclosed in U.S. Pat. Nos. 6,444,767 and 6,686,423, each incorporated herein by reference. The polymer made by such a moderated, anionic polymerization process can have the same structure as one prepared using the conventional anionic polymerization process and as such, this process can be useful in making the polymers of the present invention. For Lewis acid moderated, anionic polymerization processes, reaction temperatures between 100° C. and 150° C. are preferred as at these temperatures it is possible to take advantage of conducting the reaction at very high polymer concentrations. While a stoichiometric excess of the Lewis acid may be used, in most instances there is not sufficient benefit in improved processing to justify the additional cost of the excess Lewis acid. It is preferred to use from about 0.1 to about 1 mole of Lewis acid per mole of living, anionic chain ends to achieve an improvement in process performance with the moderated, anionic polymerization technique.

Preparation of radial (branched) polymers requires a post-polymerization step called “coupling”. In the above radial formulas n is an integer of from 2 to about 30, preferably from about 2 to about 15, and more preferably from 2 to 6, and X is the remnant or residue of a coupling agent. Varieties of coupling agents are known in the art and can be used in preparing the coupled block copolymers of the present invention. These include, for example, dihaloalkanes, silicon halides, siloxanes, multifunctional epoxides, silica compounds, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. Nos. 3,985,830; 4,391,949; and 4,444,953; as well as Canadian Pat. No. 716,645, each incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin.

In preparing the radial (branched) polymer, (C-A-B)ₙX, of the present invention, some C-A-B diblock polymer can be present but preferably at least about 70 weight percent of the block copolymer is (C-A-B)ₙ-X so as to impart strength. In the above formulas, n is an integer from 2 to about 30, preferably 2 to about 15, more preferably 2 to 6 and X is the remnant or residue of the coupling agent.

It is also important to control the molecular weight of the various blocks. For a CAB diblock, desired block weights are 1,000 to about 7,000 for the C block, 5,000 to about 20,000 for the mono alkenyl arene A block, and 20,000 to about 100,000 for the conjugated diene B block. Preferred ranges are 1,000 to about 5,000 for the C block, 6,000 to 19,000 for the A block and 25,000 to about 50,000 for the B block. The total average molecular weight for the radial copolymer should be from about 50,000 to about 200,000. As used herein, the term “molecular weights” refers to the true molecular weight in g/mol of the polymer or block of the copolymer. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, converted to true molecular weights, and are commonly referred to as “peak molecular weights”.

Another important aspect of the present invention is to control the microstructure or vinyl content of the 1,3-butadiene in the C block and the conjugated diene in the B block. The term “vinyl content” refers to the fact that a conjugated diene is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene in the B block, it is preferred that about 20 to about 80 mol percent of the condensed butadiene units in the copolymer block have 1,2 vinyl configuration as determined by proton NMR analysis, preferably about 30 to about 80 mol percent of the condensed butadiene units should have 1,2-vinyl configuration. When referring to the use of butadiene as the conjugated diene in the C block, it is preferred that about 5 to about 10 mol percent of the condensed butadiene units in the C block have 1,2 vinyl configuration as determined by proton NMR analysis. Suitable ratios of distribution agent to lithium are disclosed and taught in US Pat Re 27,145, which disclosure is incorporated by reference.

The block copolymer is selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

One of the surprising compositions of the present invention is the combination of the hydrogenated block copolymer and a polymer extending oil. Especially preferred are the types of oil that are compatible with the elastomeric segment of the block copolymer. While oils of higher aromatics content are satisfactory, those petroleum-based white oils having low volatility and less than 50% aromatic content are preferred. Typical paraffinic processing oils can be used to soften and extend polymers of the present invention; however, processing oils with a higher naphthenic content are more compatible with the rubber block. Processing oils with a naphthenic content between 40% and 55% and an aromatic content less than 10% are preferred. The oils should additionally have low volatility, preferable having an initial boiling point above about 500° F. The amount of oil employed varies from about 0 to about 300 parts by weight per hundred parts by weight rubber, or block copolymer, preferably about 20 to about 150 parts by weight.

The block copolymers of the present invention may be blended with a large variety of other polymers, including olefin polymers, styrene polymers, and tackifying resins.

In addition, the polymers of the present invention may be blended with conventional styrene/diene and hydrogenated styrene/diene block copolymers, such as the styrene block copolymers available from KRATON Polymers. These styrene block copolymers include linear S—B—S, S—I—S, S-EB—S, S-EP—S block copolymers. Also included are radial block copolymers based on styrene along with isoprene and/or butadiene and selectively hydrogenated radial block copolymers.

Olefin polymers include, for example, ethylene homopolymers, ethylene/alpha-olefin copolymers, propylene homopolymers, propylene/alpha-olefin copolymers, high impact polypropylene, butylene homopolymers, butylene/alpha olefin copolymers, and other alpha olefin copolymers or interpolymers. Representative polyolefins include, for example, but are not limited to, substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE) and high pressure low density polyethylene (LDPE). Other polymers included hereunder are ethylene/acrylic acid (EEA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, polypropylene homopolymers and copolymers, propylene/styrene copolymers, ethylene/propylene copolymers, polybutylene, ethylene carbon monoxide interpolymers (for example, ethylene/carbon monoxide (ECO) copolymer, ethylene/acrylic acid/carbon monoxide terpolymer and the like. Still other polymers included hereunder are polyvinyl chloride (PVC) and blends of PVC with other materials.

Styrene polymers include, for example, crystal polystyrene, high impact polystyrene, medium impact polystyrene, styrene/acrylonitrile copolymers, styrene/acrylonitrile/butadiene (ABS) polymers, syndiotactic polystyrene and styrene/olefin copolymers. Representative styrene/olefin copolymers are substantially random ethylene/styrene copolymers, preferably containing at least 20, more preferably equal to or greater than 25 weight percent copolymerized styrene monomer.

Tackifying resins include polystyrene block compatible resins and midblock compatible resins. The polystyrene block compatible resin may be selected from the group of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “ENDEX”, “KRISTALEX”, “NEVCHEM” and “PICCOTEX”. Resins compatible with the hydrogenated (mid) block may be selected from the group consisting of compatible C5 hydrocarbon resins, hydrogenated C5 hydrocarbon resins, styrenated C5 resins, C5/C9 resins, styrenated terpene resins, fully hydrogenated or partially hydrogenated C9 hydrocarbon resins, rosins esters, rosins derivatives and mixtures thereof. These resins are e.g. sold under the trademarks “REGALITE”, “REGALREZ”, “ESCOREZ” and “ARKON.

The polymer blends of the present invention may be compounded further with other polymers, oils, fillers, reinforcements, antioxidants, stabilizers, fire retardants, antiblocking agents, lubricants and other rubber and plastic compounding ingredients without departing from the scope of this invention.

Examples of various fillers that can be employed are found in the 1971-1972 Modern Plastics Encyclopedia, pages 240-247. A reinforcement may be defined simply as the material that is added to a resinous matrix to improve the strength of the polymer. Most of these reinforcing materials are inorganic or organic products of high molecular weight. Various examples include glass fibers, asbestos, boron fibers, carbon and graphite fibers, whiskers, quartz and silica fibers, ceramic fibers, metal fibers, natural organic fibers, and synthetic organic fibers. Especially preferred are reinforced polymer blends of the instant invention containing about 2 to about 80 percent by weight glass fibers, based on the total weight of the resulting reinforced blend. Coupling agents, such as various silanes, may be employed in the preparation of the reinforced blends.

Regarding the relative amounts of the various ingredients, this will depend in part upon the particular end use and on the particular block copolymer that is selected for the particular end use. Table B below shows some notional compositions expressed in percent weight, which are included in the present invention. For the “Polymer” amount, a portion may include conventional styrene block copolymers.

TABLE B
Applications, Compositions and Ranges

| Application | Ingredients | Composition % w. |
|---|---|---|
| Films, Molding, | Polymer | 1-99% |
| Alloys | Ethylene copolymers: | 99-1% |
| | EVA, Ethylene/styrene | |
| Personal Hygiene | Polymer | 10-75% |
| Films and Fibers | PE | 0-30% |
| | PP | 0-30% |
| | Tackifying Resin | 5-30% |
| | End Block Resin | 5-20% |
| Personal Hygiene | Polymer | 50-90% |
| Films and Fibers | PE | 5-30% |
| | PS | 0-20% |
| | Tackifying Resin | 0-40% |
| Personal Hygiene | Polymer | 45-85% |
| Films and Fibers | PS | 10-25% |
| | Oil | 5-30% |
| Extruded/Injection | Polymer | 10-85% |
| Molded articles | Polyolefin | 5-90% |
| | Oil | 0-50% |

The polymer of the present invention may be used in a large number of applications, either as a neat polymer or in a compound. The following various end uses and/or processes are meant to be illustrative, and not limiting to the present invention:
Polymer modification applications
Injection molding of toys, medical devices
Extruding films, tubing, profiles
Over molding applications for personal care, grips, soft touch applications, for automotive parts, such as airbags, steering wheels, etc
Blown film for medical devices
Blow molding for automotive/industrial parts
Films and fibers for personal hygiene applications

### EXAMPLES

The following examples are provided to illustrate the present invention. The examples are not intended to limit the scope of the present invention and they should not be so interpreted. Amounts are in weight parts or weight percentages unless otherwise indicated.

### Example 1

The block copolymers of the present invention can be readily prepared via standard anionic polymerization techniques. In this example, a block copolymer of the structure (C-A-B)ₙX is prepared, where C is a polymer of low vinyl 1,3-butadiene, Ais a polymer of styrene, B is a polymer of medium vinyl 1,3-butadiene, and X is the residue of tetraethoxysilane coupling agent.

Using a standard, living, anionic polymerization technique, a solution of butadiene, Bd, in cyclohexane (about 4.4% wt Bd) was treated with a sufficient quantity of s-butyllithium, s-BuLi, initiator to afford a living polybutadiene segment, C—Li, having, at the completion of consumption of monomer, a styrene equivalent molecular weight (MW) (MW determined by Gel Permeation Chromatography, GPC, analysis of a quenched aliquot of the living polymer solution. The GPC column was calibrated using polystyrene standards.) of 11,000 g/mol.

The living polymer solution, C—Li, was modified by the addition of diethyl ether (about 7.7% wt diethyl ether basis total solution). The resulting solution was treated with sufficient styrene, S, monomer to afford a living diblock copolymer (polybutadiene-polystyrene-Li (C-A-Li) having a styrene equivalent MW of 23,200 g/mol (from GPC analysis of a quenched aliquot). Analysis of a quenched (MeOH) aliquot of this solution using a standard proton nuclear magnetic resonance, H—NMR, technique afforded information regarding both the butadiene and the styrene segments of the block copolymer. About 65wt % of the polymer came from S monomer. For the butadiene segment, around 8% resulted from 1,2-addition of Bd monomer.

The living diblock copolymer solution, C-A-Li, was treated with sufficient Bd monomer to give a triblock copolymer (polybutadiene-polystyrene-polybutadiene-Li (C-A-B—Li)) having a styrene equivalent MW of 74,500 g/mol (from GPC analysis of a quenched (MeOH) aliquot). As outlined above, this aliquot was analyzed using a standard H—NMR technique. This analysis afforded information regarding the polystyrene block (block “A”) and the combined Bd blocks (blocks “C” and “B”). The styrene content of the triblock copolymer was about 26% wt. On average (to include both Bd blocks), 32% of the Bd monomer was added via a 1,2-addition mechanism.

The living triblock copolymer (C-A-B—Li) was coupled using tetraethoxysilane, (TEOS). Sufficient TEOS was added to link 91% of the C-A-B—Li chains together; of the coupled material, 85wt % was present as dimer, (C-A-B—)2Si(OEt)2, and the remainder was trimer (C-A-B—)3 Si(OEt).

The block copolymer so formed was then selectively hydrogenated at elevated temperature and sufficient hydrogen pressure using a standard hydrogenation catalyst. Analysis of the hydrogenated product showed that the diene polymer blocks C and B had been substantially completely hydrogenated but that the polystyrene blocks A were virtually unaffected. The selectively hydrogenated block copolymer was then recovered from the solvent, and was used in Example #2.

### Example #2

In this example, compounds based on the novel block copolymer of the present invention are compared against standard S-EB—S block copolymers (Kraton® G 1650) and controlled distribution S-EB/S—S (Kraton® RP 6936). Compound components included Drakeol 34 (a paraffinic oil supplied by Penreco) and 12 melt flow polypropylene homopolymer (5E12 supplied by Dow), along with stabilizers (e.g. Irganox 1010). The results are shown below in Table #1. As shown in Table #1, Compound 2, according to the invention, has improved tensile strength and tear strength compared with identical Compound 1 containing an S-EB—S block copolymer and with Compound 4 containing a controlled distribution block copolymer. In addition the compression set of Compound 2 at 70° C. is substantially improved (97% for Compound 1 vs 70% for Compound 2). Compound 2 shows only a slight reduction in melt flow compared to Compound 1, while Compound 4 shows a significant increase in melt flow. Compound 3 demonstrates the ability of the polymer according to the invention to also be compounded with polyethylene. Compound 3 has improved compression set at 25° C. and 70° C. as compared to Compounds 1 and 4.

TABLE #1

| | Compound 1 | | Compound 2 | | Compound 3 | | Compound 4 | |
|---|---|---|---|---|---|---|---|---|
| Formulation | phr | % | phr | % | phr | % | phr | % |
| G1650 | 100 | 44.5 | | | | | | |
| EDF 8515 | | | 100 | 44.5 | 100 | 44.5 | | |
| RP6936 | | | | | | | 100 | 42.5 |
| Drakeol 34 | 83 | 36.9 | 83 | 36.9 | 83 | 36.9 | 80 | 34.0 |
| 12 MF PP (5E12) | 41.5 | 18.5 | 41.5 | 18.5 | | | 55 | 23.4 |
| 7 MF LDPE (Huntsman 5050) | | | | | 41.5 | 18.5 | | |
| Irganox 1010 | 0.3 | 0.1 | 0.3 | 0.1 | 0.3 | 0.1 | 0.3 | 0.1 |
| Total | 224.8 | 100.0 | 224.8 | 100.0 | 224.8 | 100.0 | 235.3 | 100.0 |
| Shore A Hardness, 10 s | 64 | | 70 | | 60 | | 67 | |
| MD Tensile Properties | | | | | | | | |
| 100% Modulus, psi | 460 | | 460 | | 275 | | 500 | |
| 300% Modulus, psi | 655 | | 630 | | 385 | | 660 | |
| Strength, psi | 930 | | 1610 | | 985 | | 1240 | |
| Elongation, % | 540 | | 740 | | 750 | | 615 | |
| MD Tear Strength, pli | 248 | | 280 | | 178 | | 276 | |
| Compression set | | | | | | | | |
| 25° C./22 hrs, % | 21 | | 21 | | 15 | | 28 | |
| 70° C./22 hrs, % | 97 | | 70 | | 67 | | 96 | |
| Melt flow @ 200/5 kg | 70 | | 62 | | 25 | | 152 | |
| mold shrinkage | | | | | | | | |
| MD, in/in | 0.0084 | | 0.0071 | | 0.0194 | | 0.0096 | |
| TD, in/in | 0.0106 | | 0.0089 | | 0.0185 | | 0.0105 | |

What is claimed:

1. An article comprising at least one hydrogenated block copolymer and, optionally, at least one other component selected from the group consisting of olefin polymers, styrene polymers, tackifying resins and polymer extending oils, wherein said hydrogenated block copolymer is of the structure (C-A-B₂-A-C) or (C-A-B)ₙX, where the molecular weight of B₂ is two times that of B, n is an integer between 2 and about 30, X is the residue of a coupling agent, and wherein:
a. prior to hydrogenation each A block is a mono alkenyl arene homopolymer block, each B block is a polymer block of at least one conjugated diene and each C block is a polymer block of (i) ethylene, (ii) alpha olefins of 3 to 10 carbon atoms; or (iii) monomers of 1,3-butadiene having a vinyl content less than 10 mol percent prior to hydrogenation;
b. subsequent to hydrogenation about 0-10% of the arene double bonds have been reduced, and at least about 90% of the conjugated diene double bonds have been reduced;
c. each A block having a true number average molecular weight between about 5,000 and about 20,000, each B block having a true number average molecular weight between about 20,000 and about 100,000, and each C block having a true number average molecular weight of between about 1,000 and about 7,000; and
d. the total amount of A blocks in the hydrogenated block copolymer is about 20 percent weight to about 35 percent weight and the total amount of C blocks in the hydrogenated block copolymer is about 1 and about 5 weight percent.

2. The article according to claim 1 wherein said mono alkenyl arene is styrene and said conjugated diene is selected from the group consisting of isoprene and butadiene.

3. The article according to claim 2 wherein said conjugated diene is butadiene, and wherein about 20 to about 80 mol percent of the condensed butadiene units in block B have 1,2-configuration prior to hydrogenation.

4. The article according to claim 3 wherein said C block is a block of 1,3-butadiene having 5 to 10 mol percent 1,2-configuration prior to hydrogenation.

5. The article according to claim 4 wherein the A blocks each have a mol weight of 6,000 to 19,000, the B blocks each have a mol weight of 25,000 to 70,000 and the C blocks each have a mol weight of 1,000 to 5,000.

6. The article according to claim 5 comprising 100 parts by weight of said hydrogenated block copolymer and about 20 to about 200 parts by weight of a polymer extending oil.

7. The article according to claim 6 wherein said extending oil is a paraffinic oil.

8. The article according to claim 5 comprising 100 parts by weight of said hydrogenated block copolymer, about 20 to about 200 parts by weight of an extending oil and about 10 to about 100 parts by weight of an olefin polymer selected from the group consisting of ethylene homopolymers, ethylene/alpha olefin copolymers, propylene homopolymers, propylene/alpha olefin copolymers, high impact polypropylene, and ethylene/vinyl acetate copolymers.

9. The article according to claim 6 also comprising about 5 to about 50 parts by weight of a tackifying resin.

10. The article according to claim 6 also comprising about 5 to about 40 parts by weight of a styrene polymer selected from the group consisting of crystal polystyrene, high impact polystyrene, syndiotactic polystyrene and acrylonitrile/butadiene/styrene terpolymer.

11. A formulated elastomeric composition comprising at least one hydrogenated block copolymer and at least one component selected from the group consisting of fillers, reinforcements, polymer extending oils, tackifying resins, lubricants and polyolefins, wherein said hydrogenated copolymer is of the structure C-A-B₂-A-C or (C-A-B)ₙX, where the molecular weight of B₂ is twice that of B, n is an integer between 2 and about 30, X is the residue of a coupling agent, and wherein:
a. prior to hydrogenation each A block is a mono alkenyl arene homopolymer block, each B block is a polymer block of at least one conjugated diene and each C block is a polymer block of (i) ethylene, (ii) alpha olefins of 3 to 10 carbon atoms; or (iii) monomers of 1,3-butadiene having a vinyl content less than 10 mol percent prior to hydrogenation;
b. subsequent to hydrogenation about 0-10% of the arene double bonds have been reduced, and at least about 90% of the conjugated diene double bonds have been reduced;
c. each A block having a true number average molecular weight between about 5,000 and about 20,000, each B block having a true number average molecular weight between about 20,000 and about 100,000, and each C block having a true number average molecular weight of between about 1,000 and about 7,000; and
d. the total amount of A blocks in the hydrogenated block copolymer is about 20 percent weight to about 35 percent weight and the total amount of C blocks in the hydrogenated block copolymer is about 2 and about 10 weight percent.

12. The article according to claim 1 wherein the article is in the form of a film, sheet, coating, band, strip, profile, molding, foam, tape, fabric, thread, filament, ribbon, fiber, plurality of fibers or fibrous web.

13. The article according to claim 1 wherein said article is formed in a process selected from the group consisting of injection molding, over molding, dipping, extrusion, roto molding, slush molding, fiber spinning, film making or foaming.
